(19) United States
(12) Patent Application Publication
(10) Pub. No.: US 2004/0138906 A1
(43) Pub. Date: Jul. 15, 2004

(54) Custom destination guidebook system

(76) Inventor: Catherine J.M. Fagan, Medford, MA (US)

Correspondence Address: Iandiorio & Teska, 260 Bear Hill Road, Waltham, MA, 02451-1018, US

(21) Appl. No.: 10/607,364

(22) Filed: Jun. 26, 2003

Related U.S. Application Data
(60) Provisional application No. 60/392,865, filed on Jul. 1, 2002.

(51) Int. Cl. G06F 17/60

(52) U.S. Cl. 705/1

(57) ABSTRACT

A custom destination guidebook system and method including a database of guide profiles including destination specific information. A first routine generates a profile screen wherein specific data relating to a traveler can be entered to generate a traveler profile. A software engine is configured to associate the traveler profile with one or more guide profiles stored in the database. A second routine assembles a customized guidebook for the traveler for viewing and/or printing.

### RELATED APPLICATIONS

This application claims priority of U.S. Provisional application Serial No. 60/392,865, filed Jul. 1, 2002.

### FIELD OF THE INVENTION

This invention relates to a system configured to produce customized destination guidebooks.

### BACKGROUND OF THE INVENTION

The travel industry, which includes popular destinations (e.g., Orlando, Fla.), attractions (e.g., Universal Studios), recreational activities (e.g., golf courses), hotels, dining establishments, booking agents, tour guides, and travel agencies, has long taken advantage of the internet to provide, inter alia, virtual tours of a destination, attraction, or hotel; booking; reservations; and the like.

In addition to internet resources, travelers may also purchase or download guidebooks specific to a given destination. But, typical guidebooks are not traveler specific. In other words, the guidebook authors attempt to target all travelers and the resulting guidebooks are therefore quite comprehensive and lengthy.

A family of four with teenage children and of average income, however is interested in different information concerning a destination than a wealthy couple who are primarily interested in golfing. Currently, both sets of travelers would purchase the same comprehensive guidebook resulting in a waste of money and time since the family of four is not interested in the guidebook sections on luxury hotels or golf courses and, conversely, the wealthy couple is not interested in the guidebook sections covering attractions targeting children.

### SUMMARY OF THE INVENTION

It is therefore an object of this invention to provide a custom destination guidebook system.

It is a further object of this invention to provide such a system which saves travelers time and money.

It is a further object of this invention to provide such a system which outputs customized guidebooks specific to the interests of individual travelers and their companions as a supplement to internet based virtual tours, booking, and other travel industry marketing and advertising endeavors.

It is a further object of this invention to provide a business model wherein revenue is generated by allowing travel industry partners to sponsor the customized guidebooks.

The invention results from the realization that a customized guidebook production system is effected by querying the traveler to generate a traveler profile, matching the traveler profile with a stored set of destination specific guide profiles, and assembling a customized guidebook which includes the guide profiles appropriate for the traveler profile.

This invention features a custom destination guidebook system comprising a database of guide profiles including destination specific information, a first routine which generates a profile screen wherein specific data relating to a traveler can be entered to generate a traveler profile, a software engine configured to associate the traveler profile with one or more guide profiles stored in the database, and a second routine which assembles a customized guidebook for the traveler for viewing and/or printing.

Typically, the database further also includes generic information for the destination added to each customized guidebook. In one example, the guide profiles stored in the database correspond on a one to one basis to different traveler data. The specific data for each traveler may include the traveler's name, age group, dining preferences, an indication whether children will be traveling, attractions of interest, and/or recreational activities of interest. The guide profiles stored in the database may include different information for different age travelers, different dining preferences for travelers, different information for travelers with and without children, different information for travelers interested in different attractions, and different information for travelers interested in different recreational interests. In one embodiment, the second routine associates a sponsor with the customized guidebook.

One custom destination guidebook system in accordance with the invention includes a database populated with guidebook sections each including at least one unique identifier. A first routine allows a user to generate a traveler profile by inputting data specific to the user and which assigns a unique identifier to the inputted data. A software engine is configured to associate the traveler profile with the guidebook sections by correlating the unique identifier assigned to the inputted data with each guidebook section. A second routine assembles a customized guidebook including the guidebook sections having identifiers which match the identifiers associated with the data specific to the traveler for viewing and/or printing by the traveler.

A method of customizing a guidebook for a traveler in accordance with this invention features allowing a traveler to input data related to the traveler, generating a traveler profile based on the inputted data, associating the traveler profile with one or more guide profiles, and assembling the guide profiles together as a custom guidebook for viewing and/or printing by the traveler.

The database may further also includes generic information for the destination added to each customized guidebook. In one example, the guide profiles stored in the database correspond on a one to one basis to different traveler data. The specific data for each traveler may include the traveler's name, age group, dining preferences, an indication whether children will be traveling, attractions of interest, or recreational activities of interest. The guide profiles stored in the database may include different information for different age travelers, different dining preferences, different information for travelers with and without children, different information for travelers interested in different attractions, and different information for travelers interest in different recreational interests. The preferred method further includes associating a sponsor with the customized guidebook.

In accordance with one method of the subject invention, a user generates a traveler profile by inputting data specific to, the user, a unique identifier is assigned to the inputted data, the traveler profile is associated with guidebook sections stored in a database by correlating the unique identifier assigned to the inputted data with each guidebook section, and a customized guidebook is assembled including the guidebook sections having identifiers which match the identifiers associated with the data specific to the traveler for viewing and/or printing by the traveler..

The subject invention also features a travel sponsor custom guidebook method comprising allowing a sponsor to sponsor, a customized guidebook, allowing a traveler to generate a traveler profile, and assembling a customized guidebook for the traveler including guide profiles corresponding to the traveler profile and including information about the sponsor.

### BRIEF OF DESCRIPTION OF THF DRAWING

Other objects, features and advantages will occur to those skilled in the art from the following description of a preferred embodiment and the accompanying drawings, in which:

FIG. 1 is an example of a screen shot showing an exemplary home page screen produced by the custom destination guidebook system of the subject invention;

FIG. 2 is an example of a screen shot of a typical profile screen;

FIG. 3 is a block diagram showing, in one embodiment, the primary components of a customized guidebook system and method in accordance with the subject invention;

FIG. 4 is an exemplary'screen shot showing another profile screen served up by the system of FIG. 3;

FIGS. 5A-5S are an example of a customized guidebook produced by the system of the subject invention for a traveler who has entered the profile information shown in FIG. 4;

FIG. 6 is a screen shot showing another profile screen served up in accordance with the system of the subject invention; and

FIGS. 7A-7N are an example of a guidebook produced by the system of the subject invention for a traveler with the profile information entered in the entries of the profile screen shown in FIG. 6.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

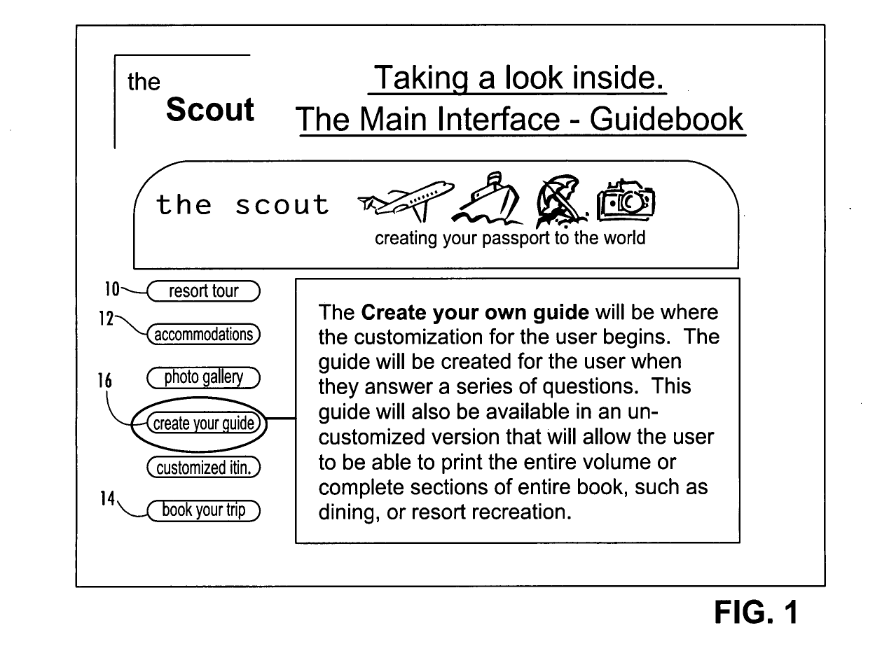

FIG. 1 shows an exemplary home page screen produced by the customized destination guidebook system of the subject invention. Typical user choices are the ability to take a virtual tour of a given destination by clicking on the “resort tour” button 10, to view a list of accommodations via button 12 with hyperlinks to the web pages of the individual hotels, to book a trip via button 14, and the like.

Unique to the subject invention is button 16 which, when clicked, allows the traveler to create a custom destination guidebook. The system of the subject invention includes a first routine, algorithm, or set of computer instructions which, when button 16 is activated, generate a profile screen wherein specific data relating to a traveler can be entered to generate a traveler profile.

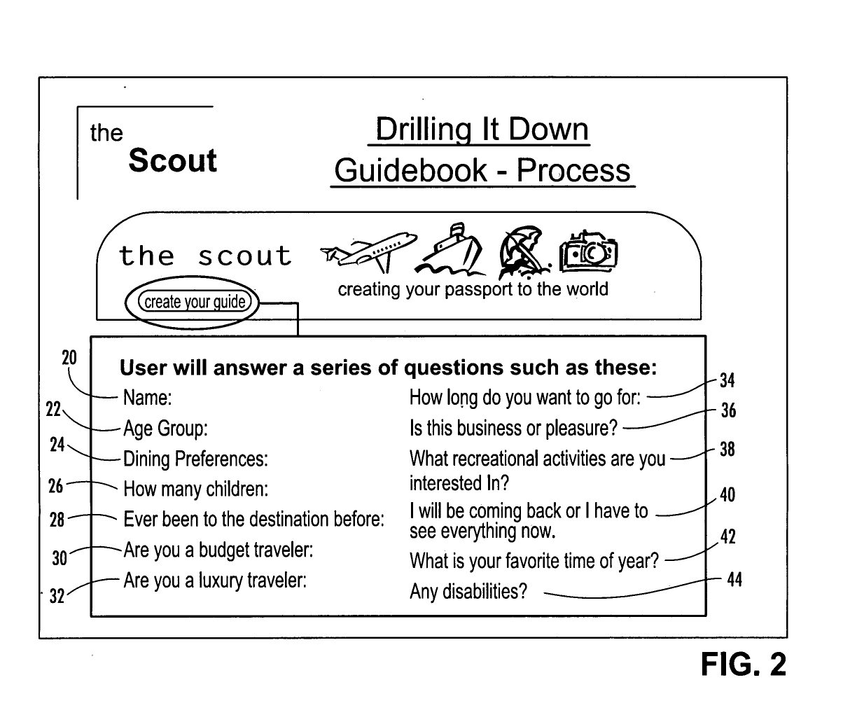

One example of such a profile screen is shown in FIG. 2. The specific data for each traveler includes the traveler's name 20, the age group 22, dining preferences 24, how many children will be making the trip 26, whether the traveler has ever been to the destination before 28, whether the traveler is a budget traveler 30, whether the traveler is a luxury traveler 32, the length of the vacation 34, whether the vacation is for business or pleasure 36, a listing of recreational activities the traveler may be interested in 38, an indication whether the traveler will be returning or whether the traveler desires to see all of the attractions on the trip being booked 40, an indication of the traveler's favorite time of year 42, and whether the traveler or anyone in the traveler's party has any disabilities 44.

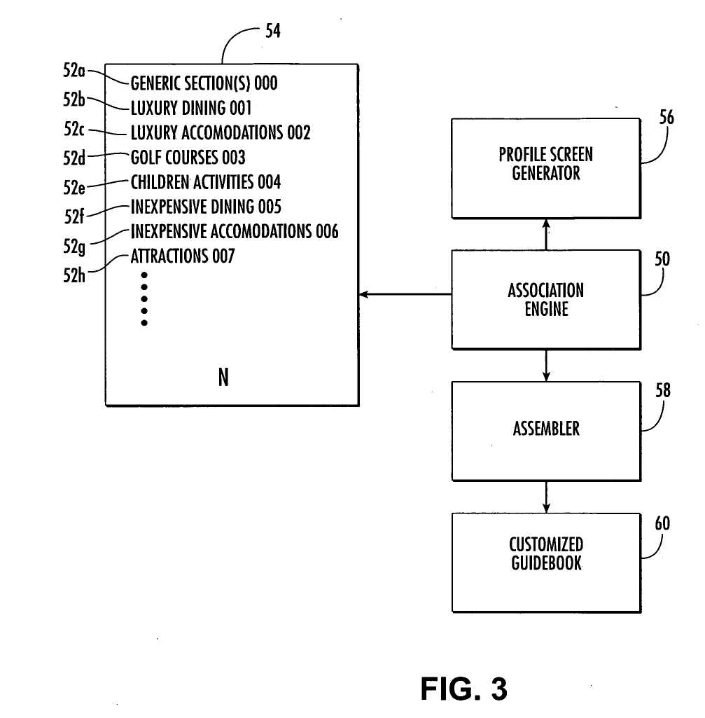

After the user fills out this information, association engine 50, FIG. 3 associates the traveler profile with one or more guide profiles 52b-h, stored in database 54. The guide profiles stored in the database include different information for different age travelers, different dining preferences for travelers, different information for travelers with and without children, different in for travelers interested in attractions, and different information for travelers interested in different recreational activities. There may be many, e.g., hundreds, of such profiles. There may also be generic information 52a stored in database 54, e.g., airport information, provided in every customized guidebook.

Thus, in the preferred embodiment, profile screen generator 56 generates the profile screen of FIG. 2 and association engine 50 assigns an identifier 001-N to each entry of the user supplied data. So, for example, if the user answers “yes” to query 32. FIG. 2, that response is assigned the number 002. If, in contrast, the traveler answers “yes” to query 30, FIG. 2, that response is assigned the numbers 005 and 006, FIG. 3.

In the first example, association engine 50, FIG. 3 would associates guidebook profile 52c of database 54 with the traveler and assembler 58 assembles customized guidebook 60 for the traveler containing information regarding luxury accommodations. That customized guidebook will not include profiles 52f (“inexpensive dining”), 52g (“inexpensive accommodations”), and the like. In the second example, association engine 50 would associate guidebook profiles 52e and 52f of database 54 with the traveler and assembler 58 would assemble a customized guidebook 60 for the traveler containing information regarding inexpensive accommodations and dinning establishments. That customized guidebook would not include profiles 52c (luxury accommodations).

Each customized guidebook can then be printed out by the user and/or viewed online and/or imported to a handheld device such as a Palm Pilot as is known in the art. And, each user's profile can be stored so that travel industry participants, for example a sponsor, can access the traveler profile and learn about the traveler and better serve his or her needs and requirements.

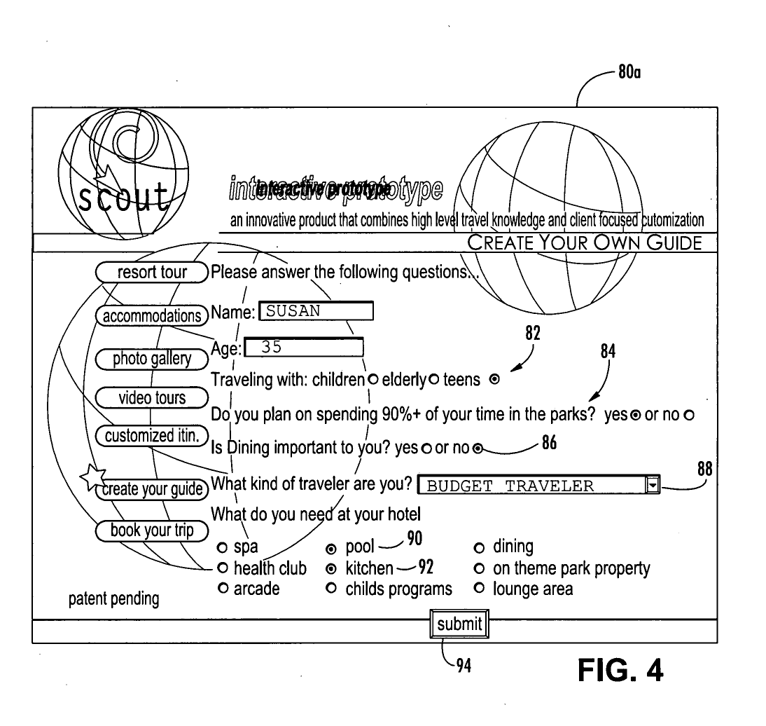

In the example shown in FIG. 4, profile screen generator 56, FIG. 3 produces profile screen 80a, FIG. 4 and the user has indicated she is traveling with teens at entry 82, that theme parks are of primary importance at entry 84, that dining is not important at entry 86, that the traveler is a budget traveler at entry 88 and that the traveler requests a pool 90 and a kitchen 92 at the hotel.

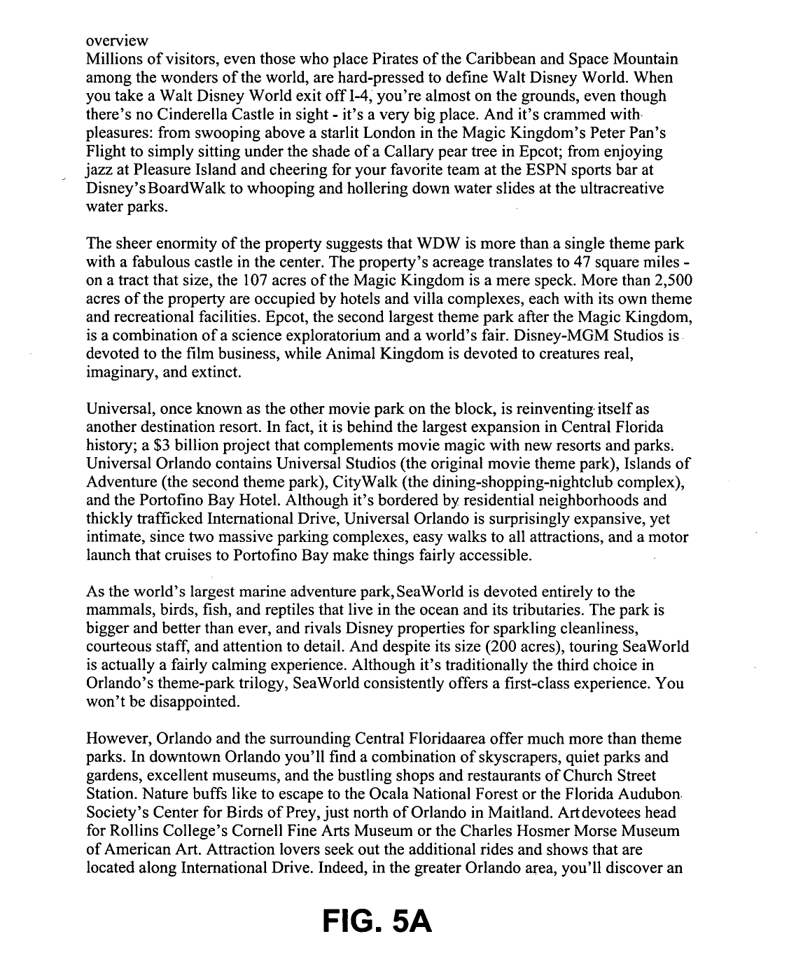

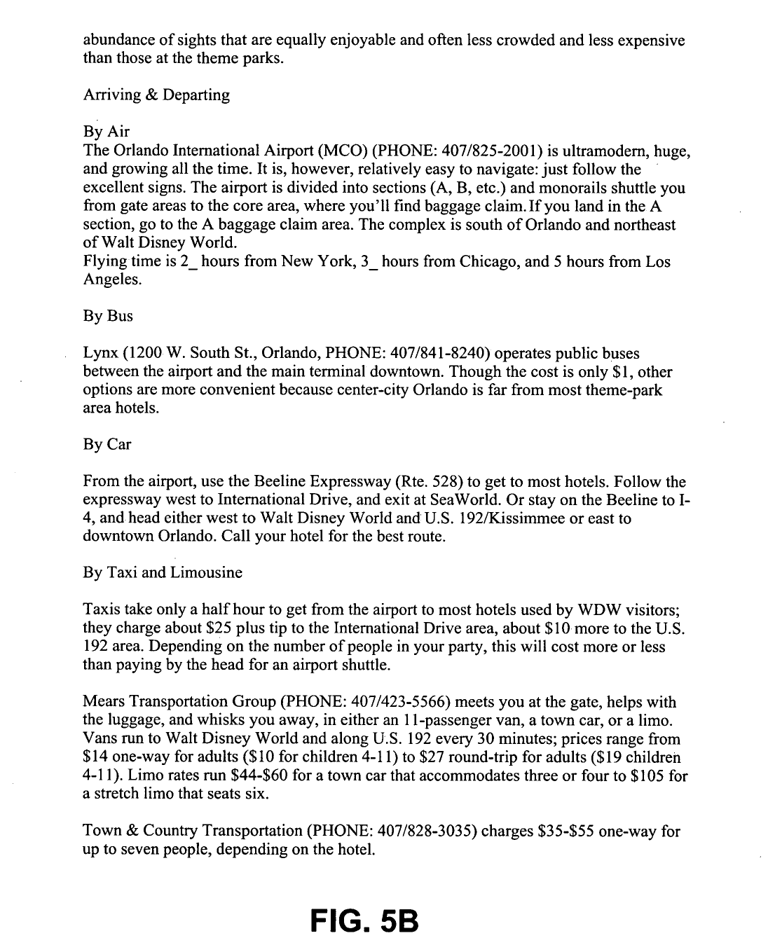

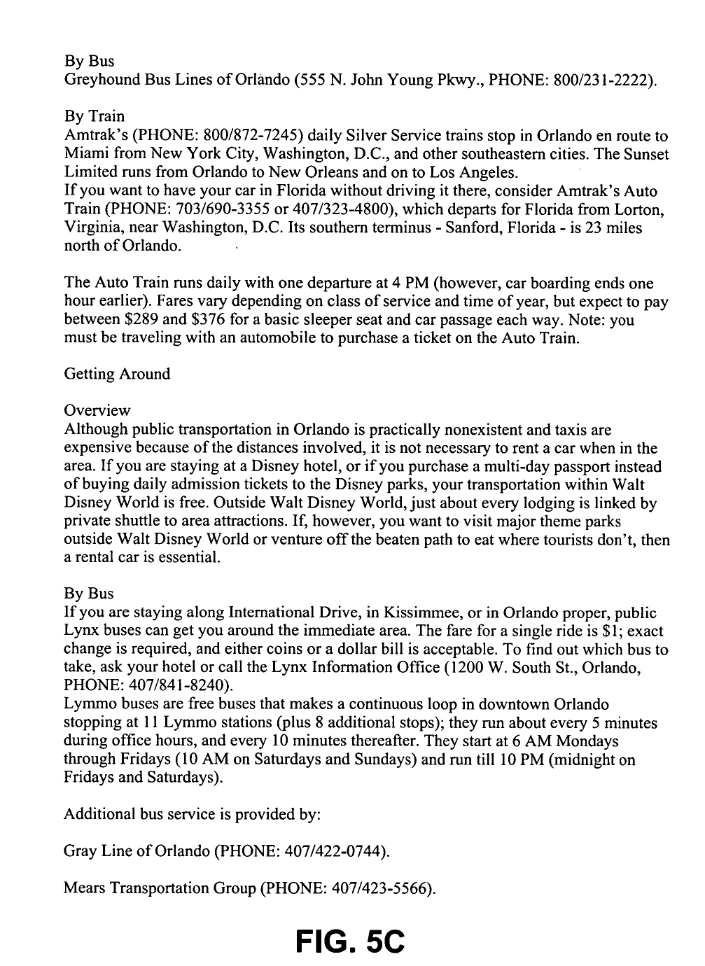

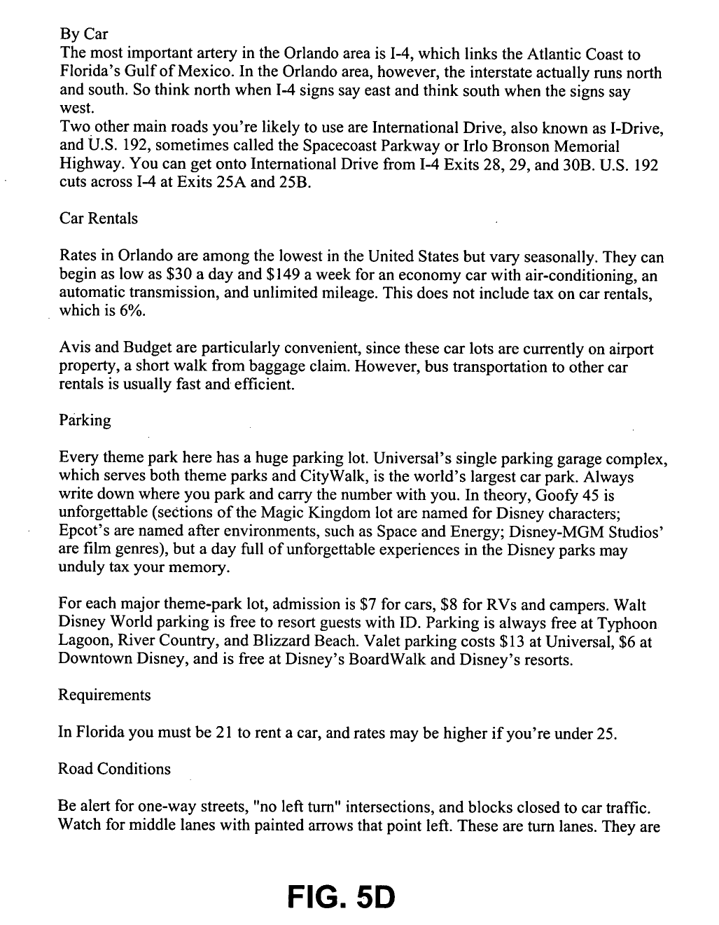

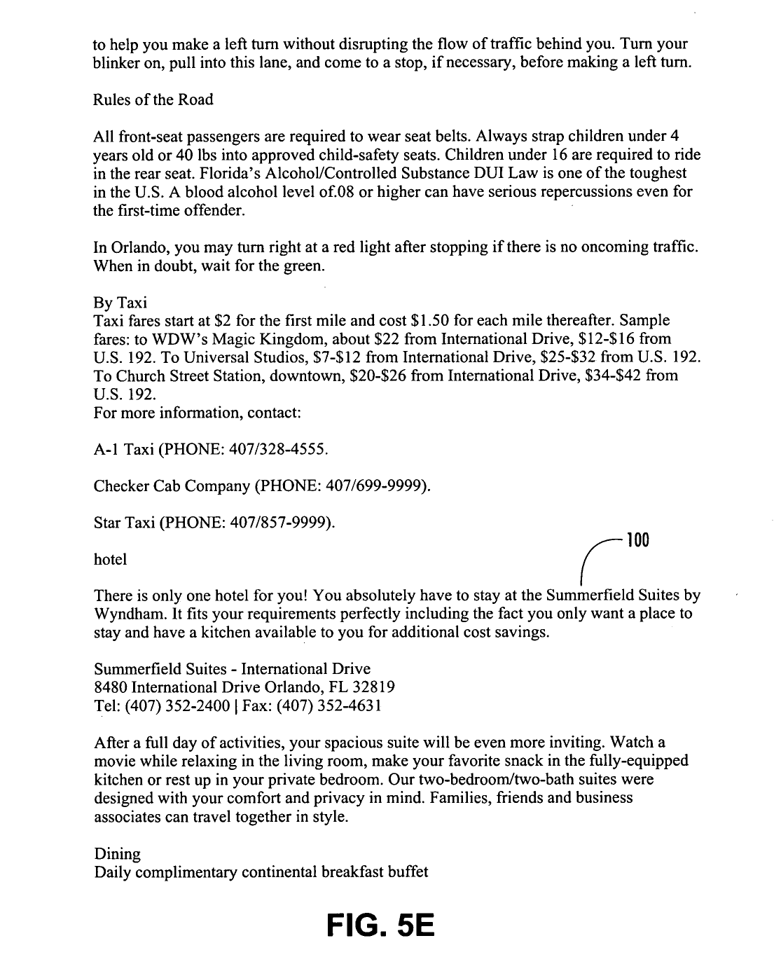

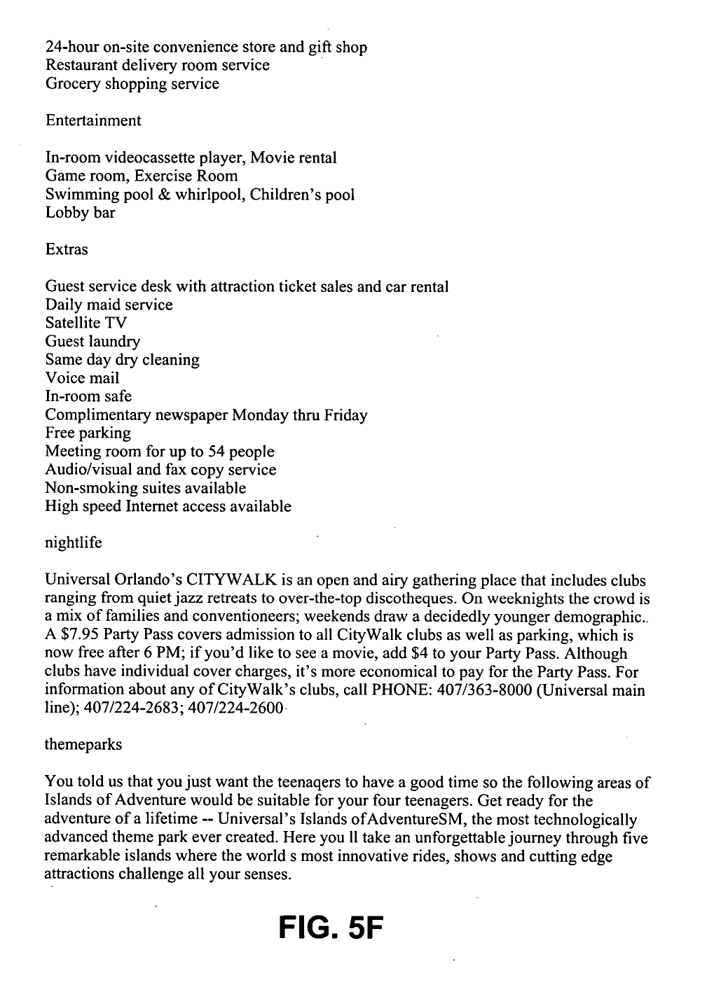

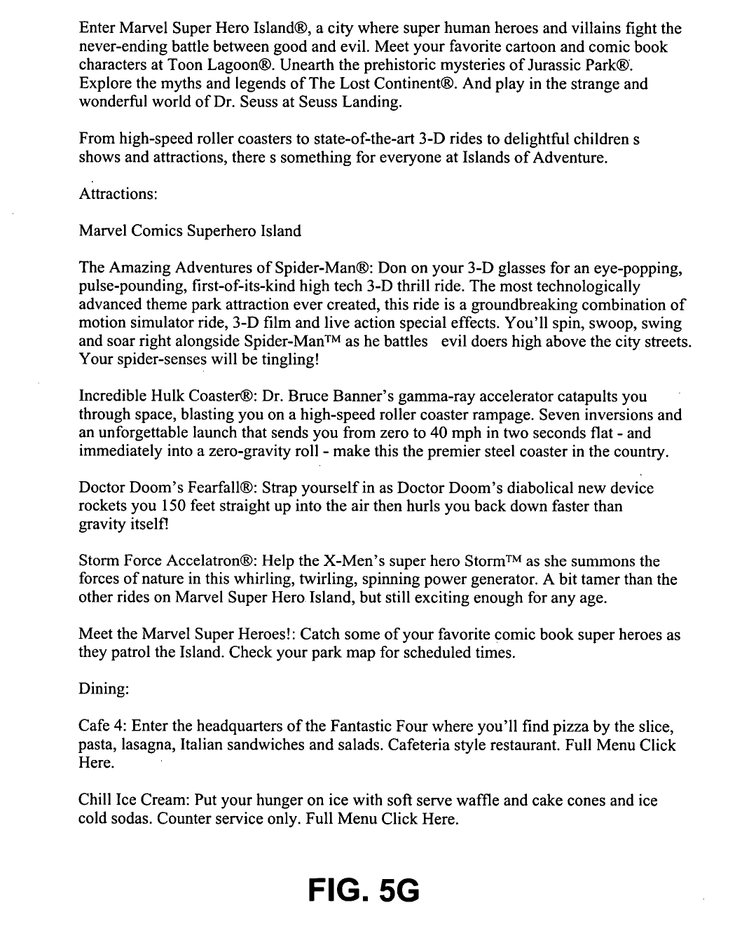

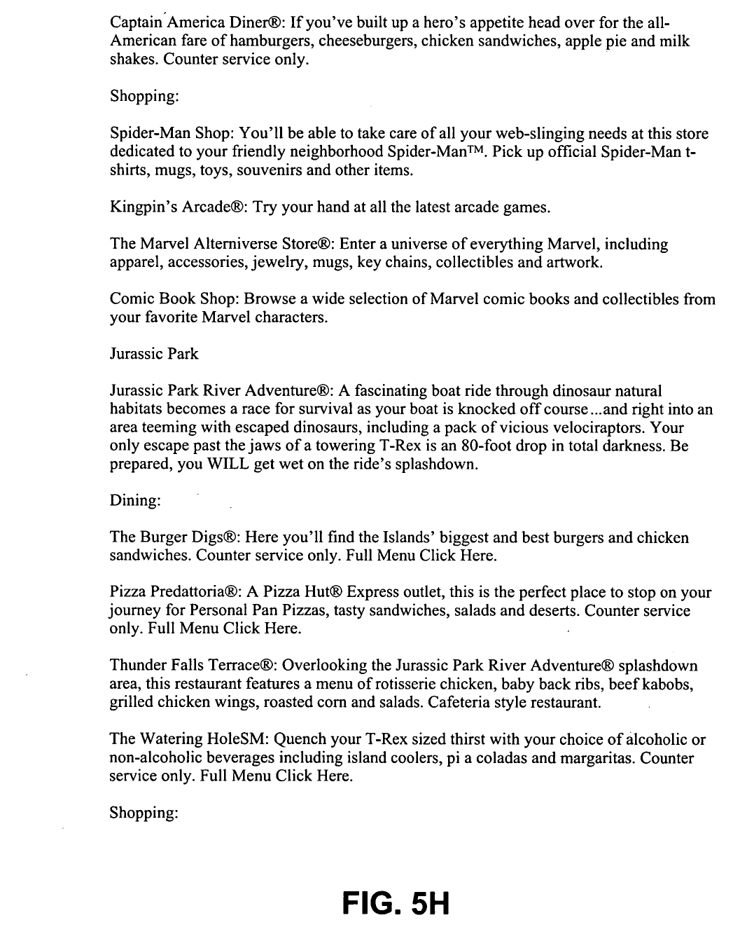

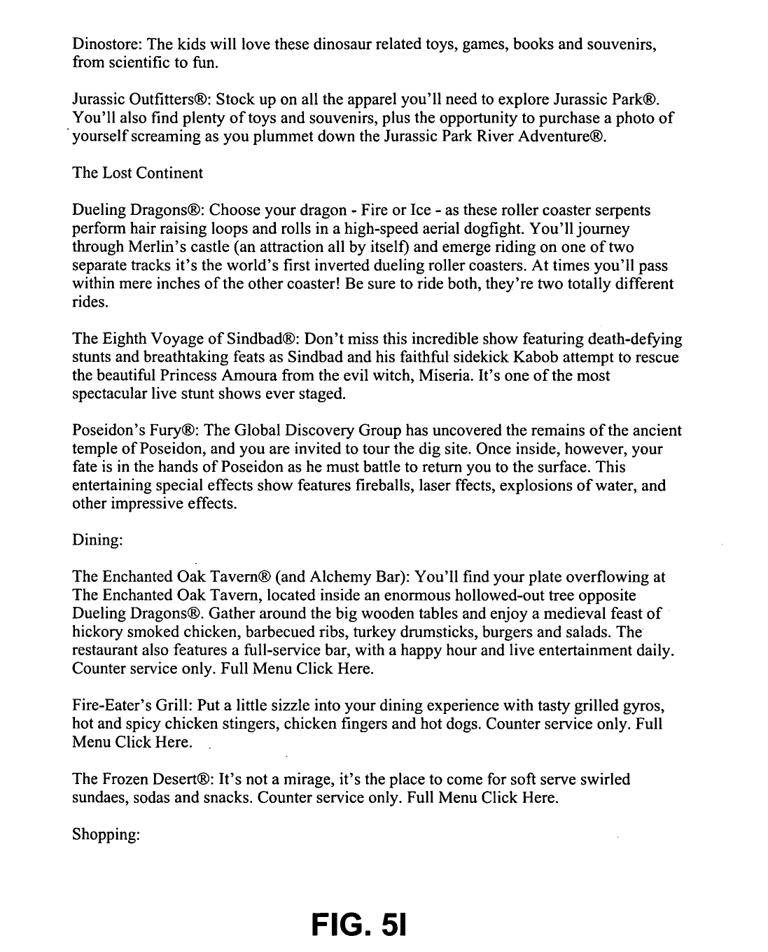

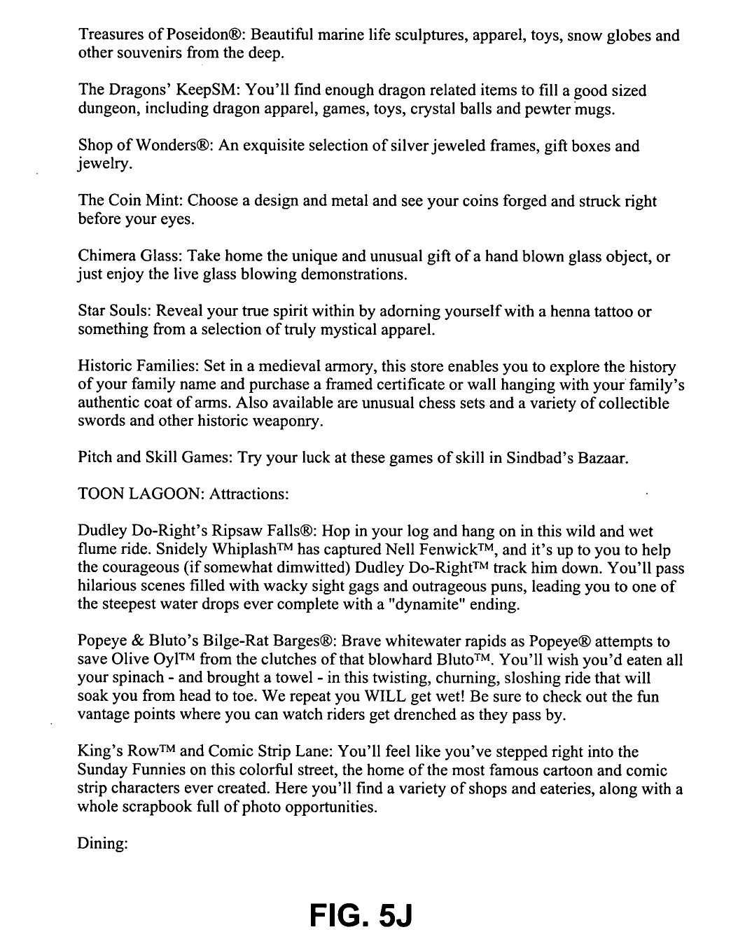

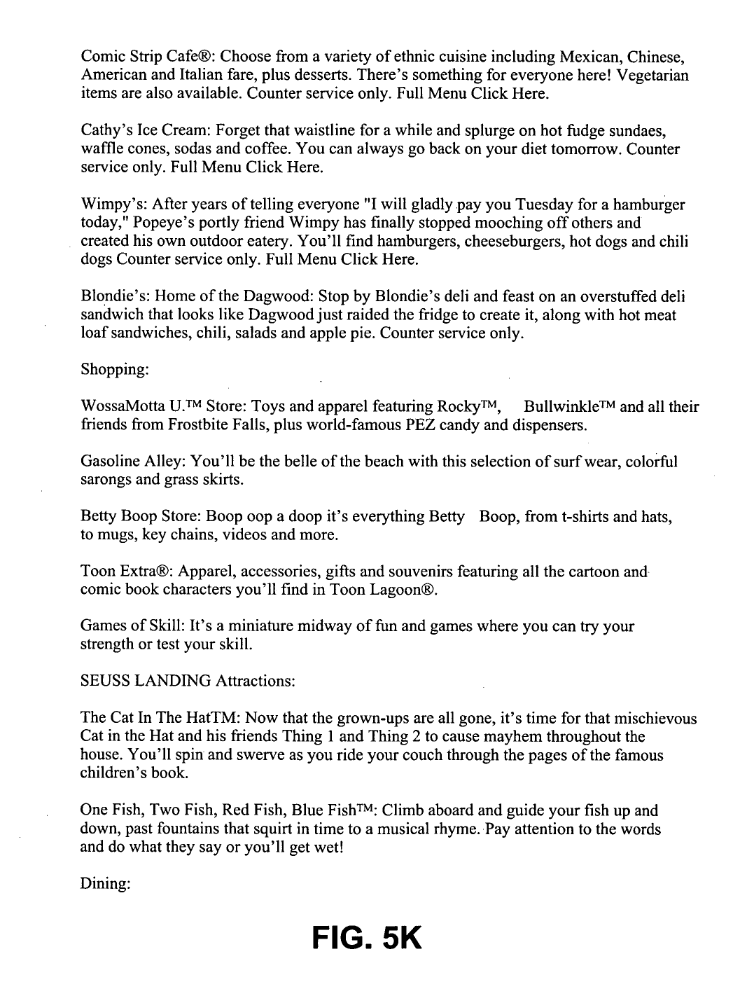

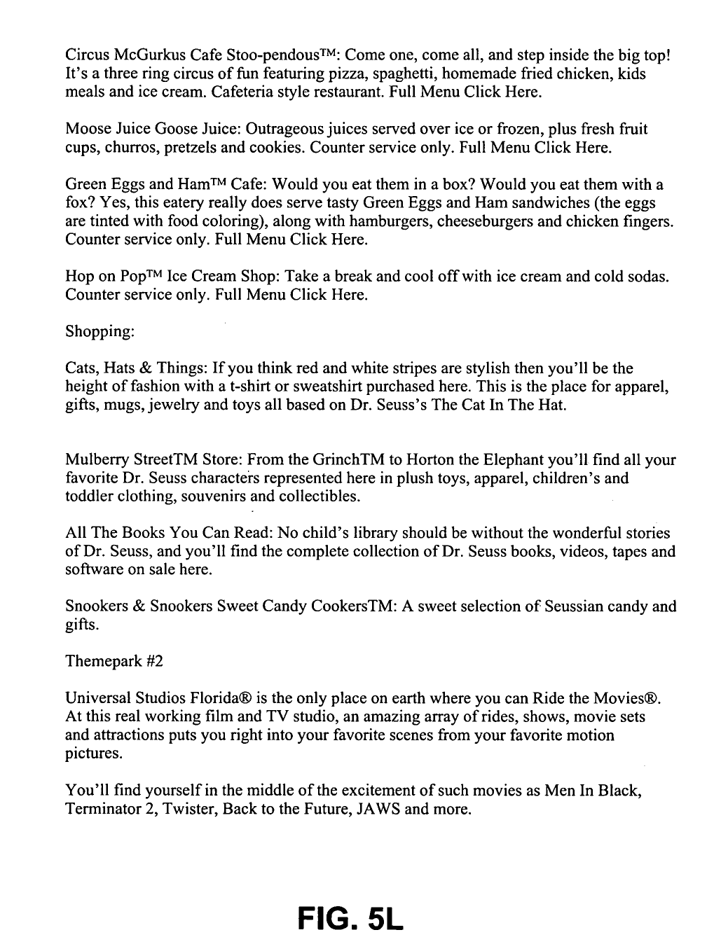

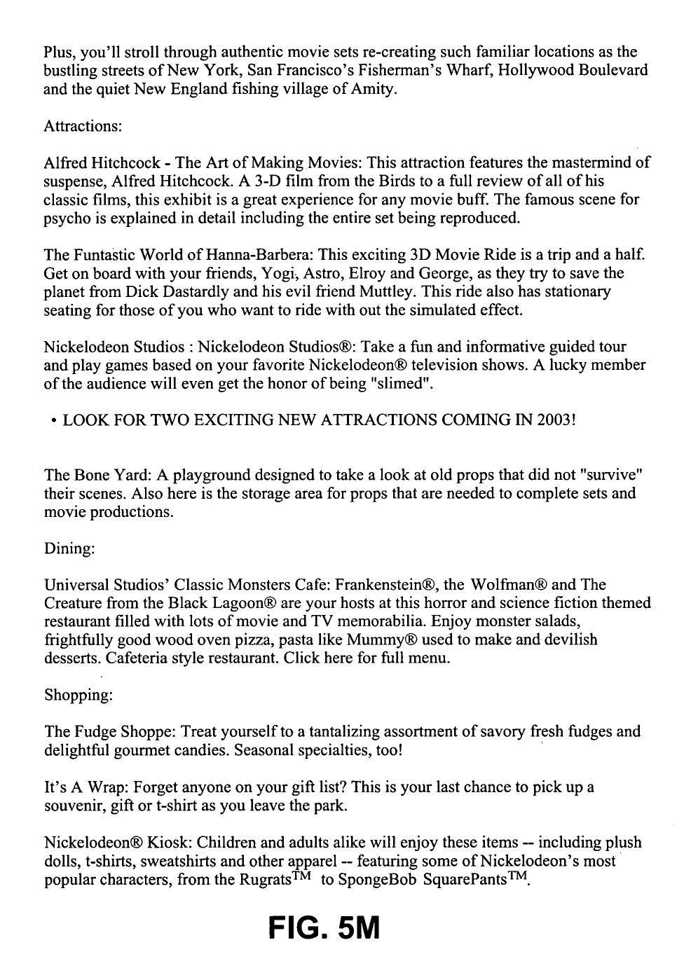

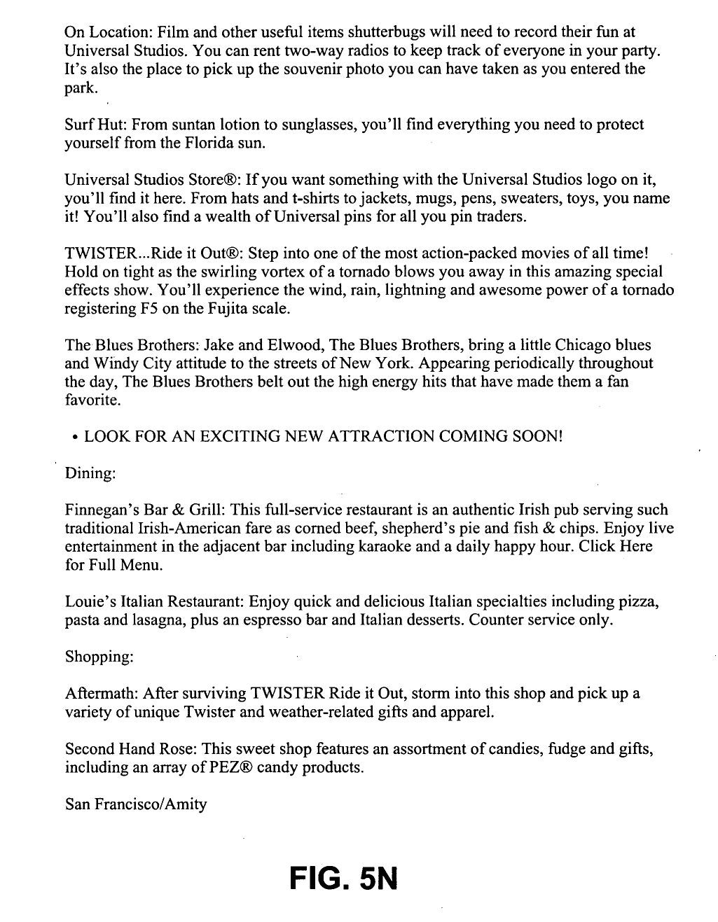

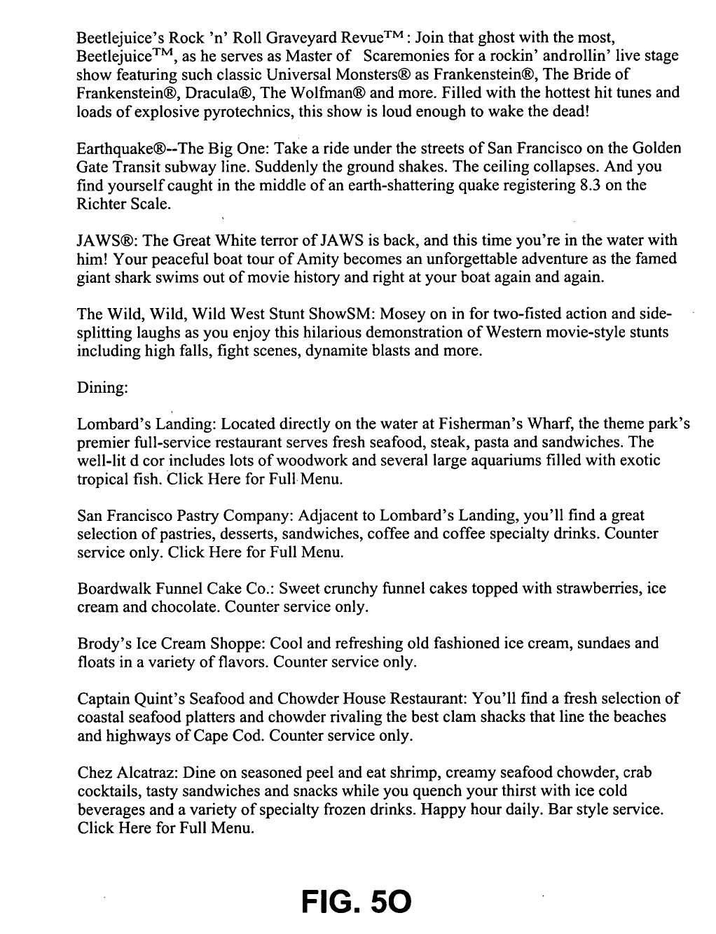

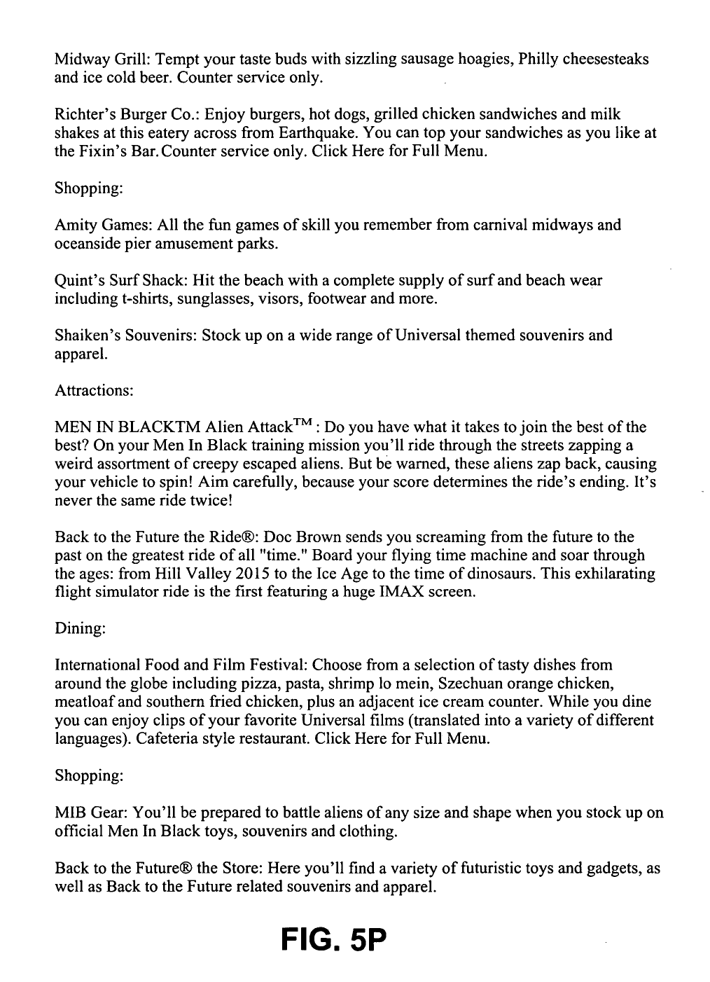

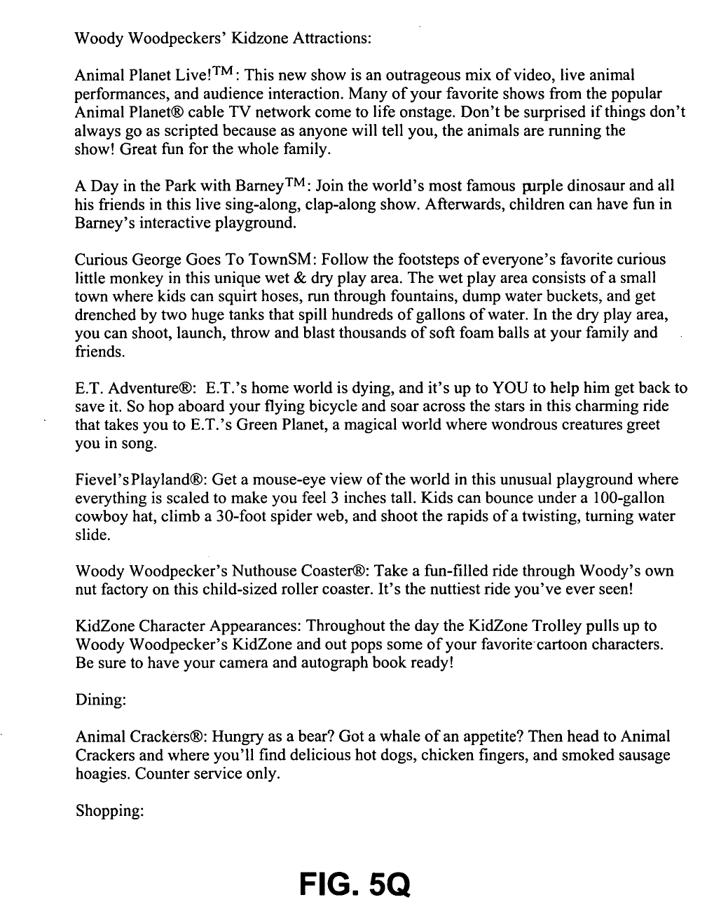

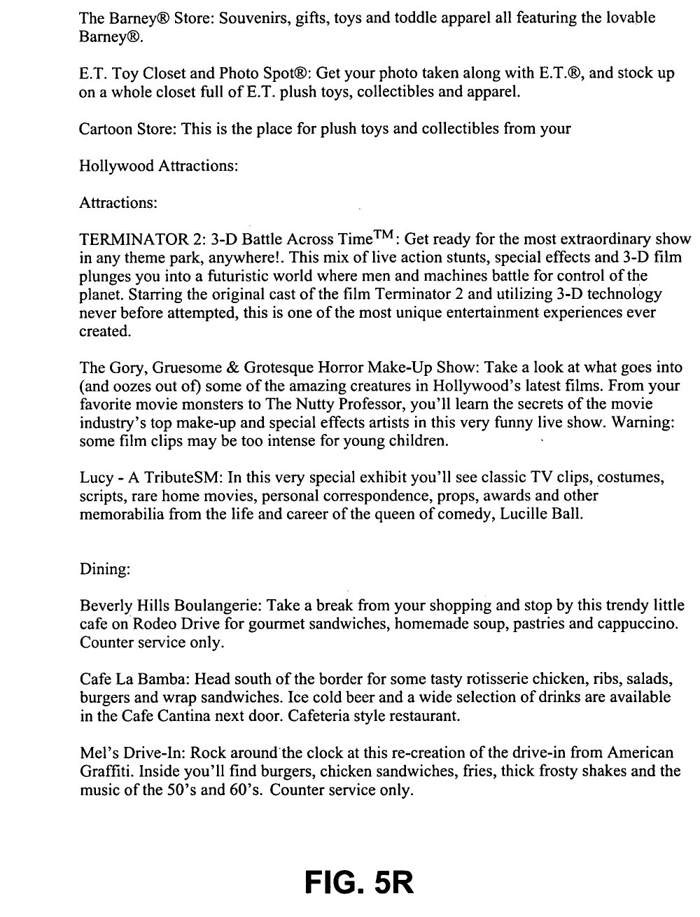

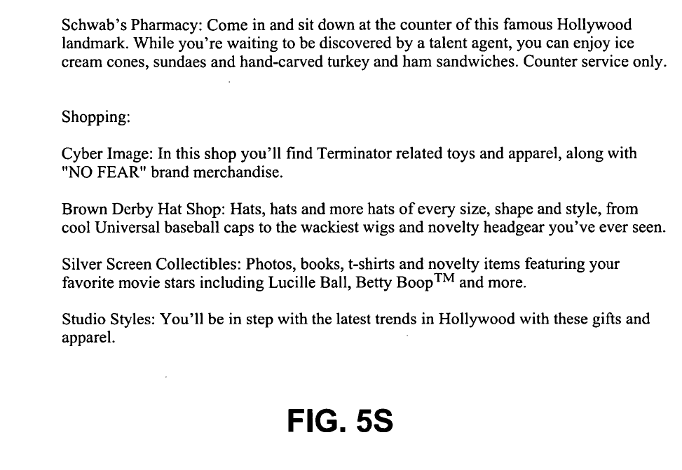

After the submit button 94 is activated, association engine 50, FIG. 3 and assembler 58 produce customized guidebook 60′, FIGS. 5A-5S. Generic information is shown in FIGS. 5A-5D. Note, however, the hotel recommendation 100, FIG. 5E which includes a kitchen and the numerous theme park and attraction guide entries of FIGS. 5F-5S.

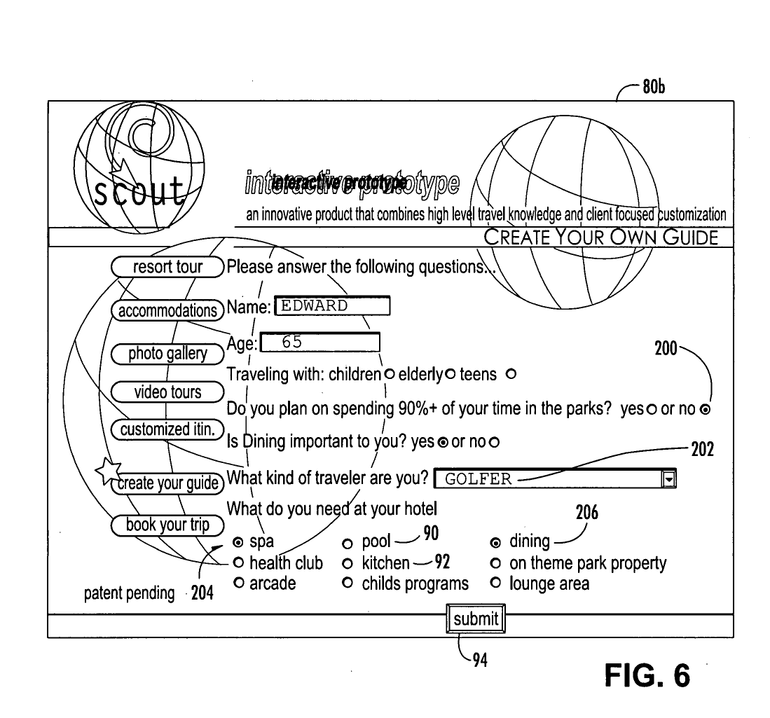

In sharp contrast, an elderly man completing profile screen 80b, FIG. 6 has no children traveling with him and will not visit theme parks or attractions as shown at 200. And, this traveler is primarily interested in golf as shown at entry 202, requires a spa at the hotel as shown by entry 204, and is interested in fine dining as shown at entry 206.

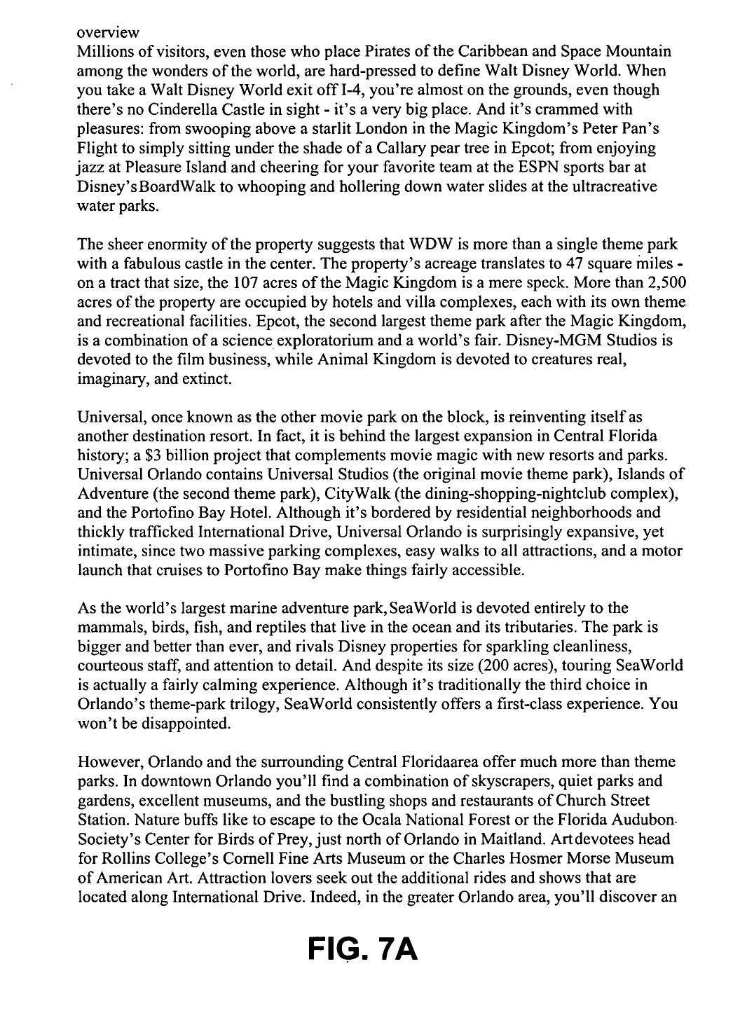

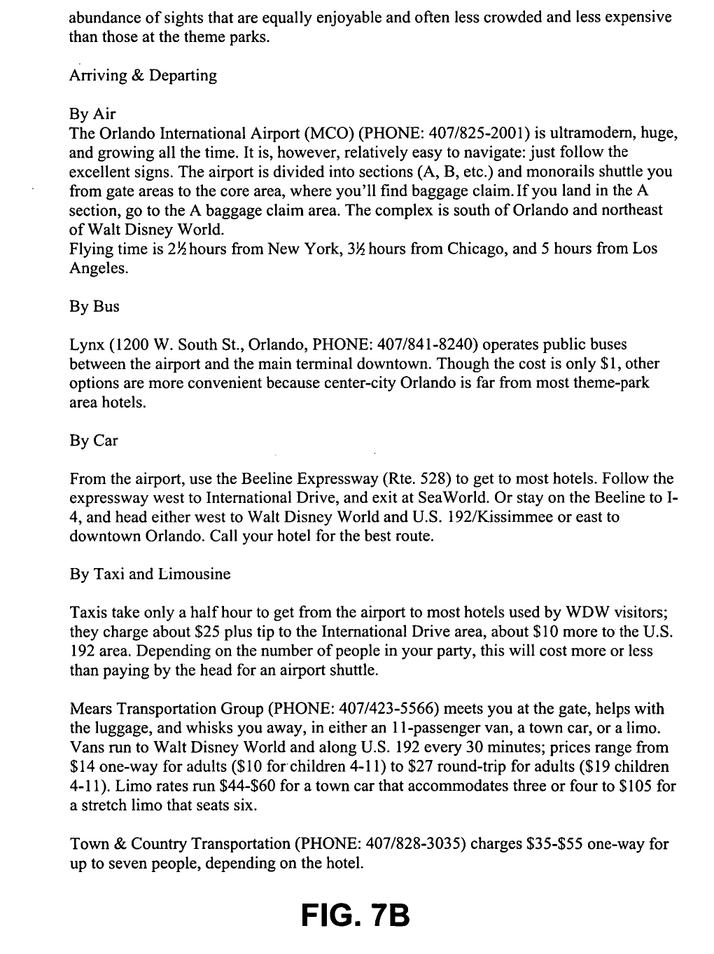

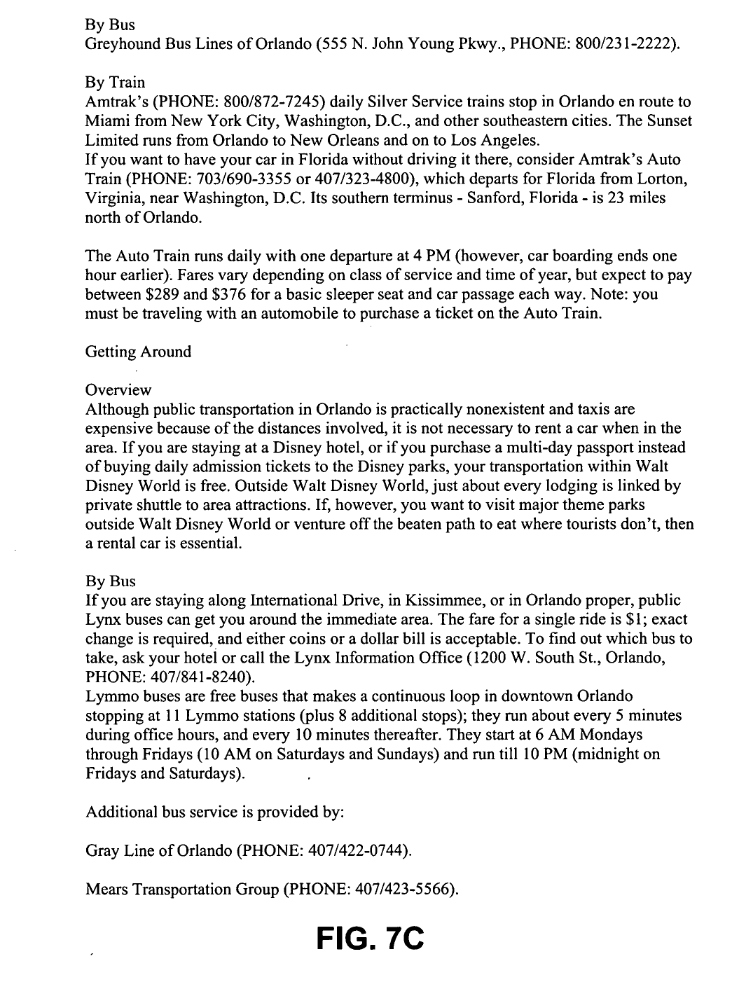

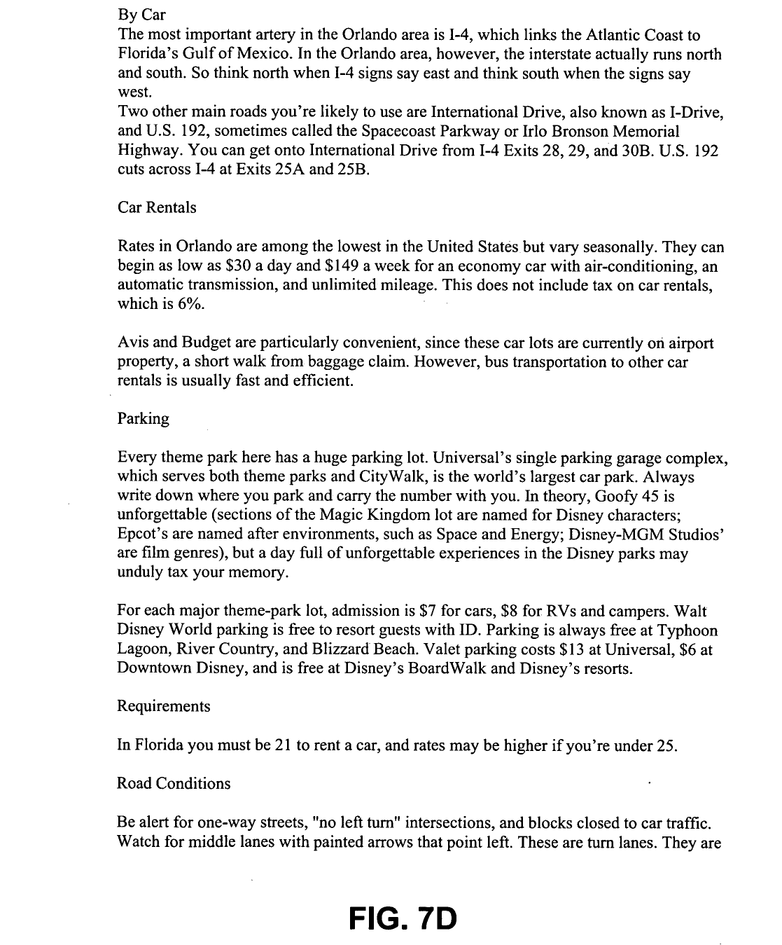

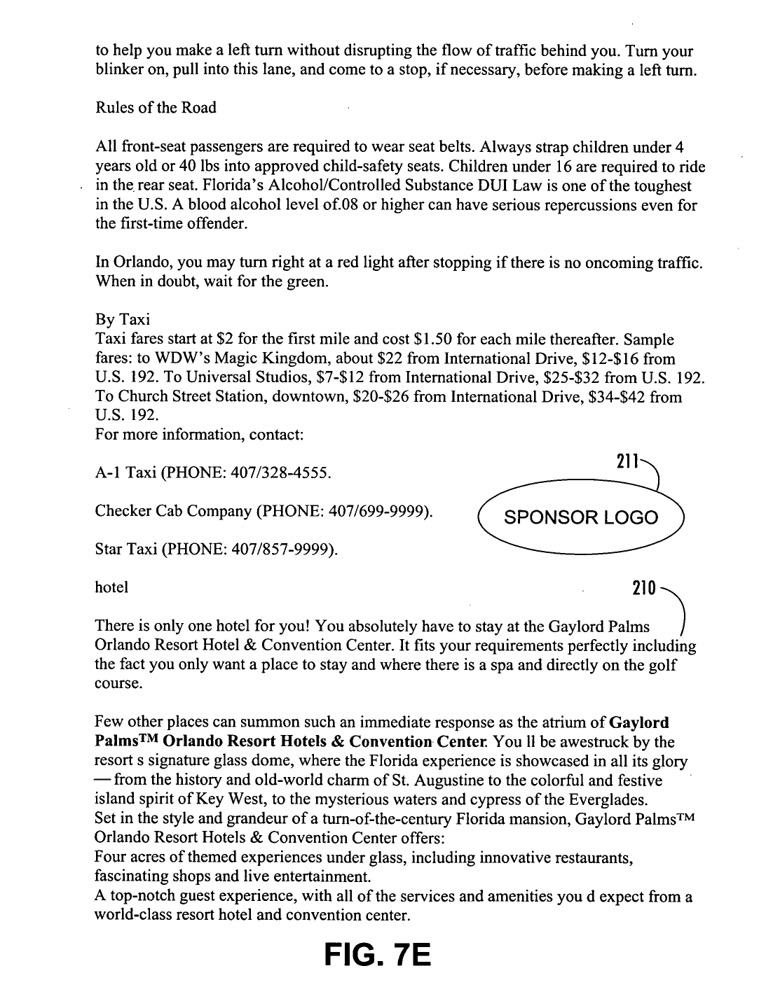

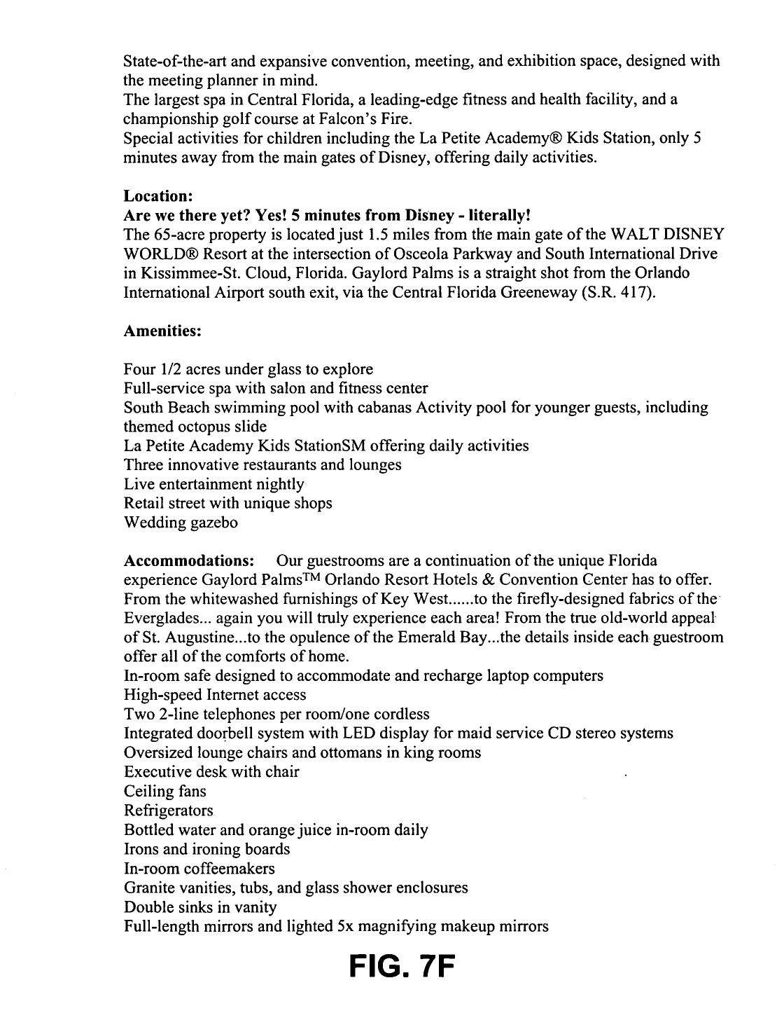

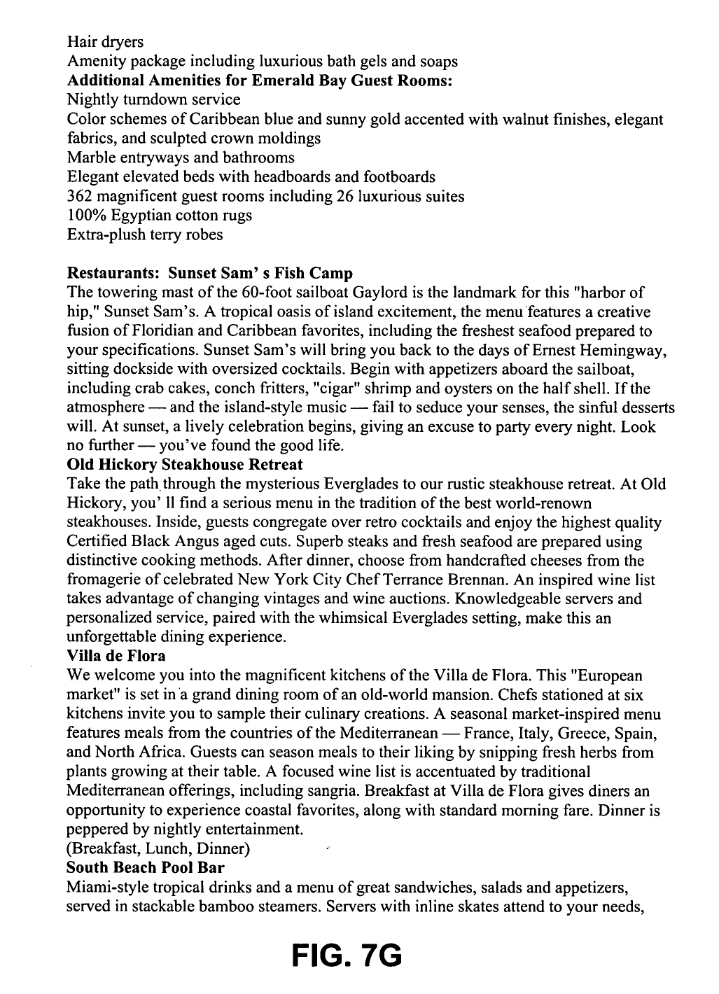

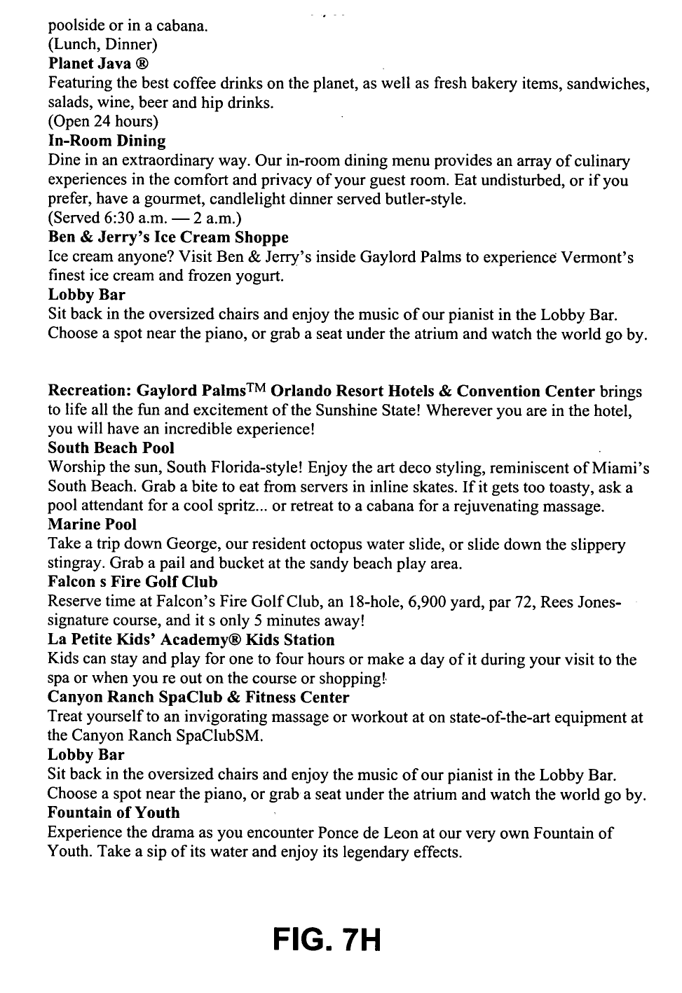

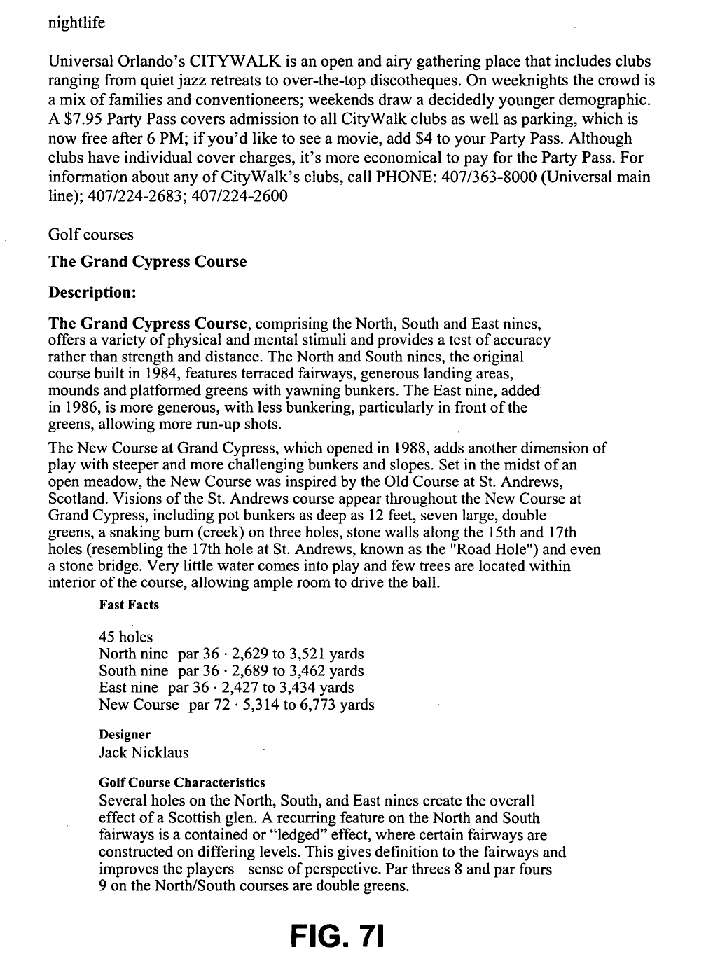

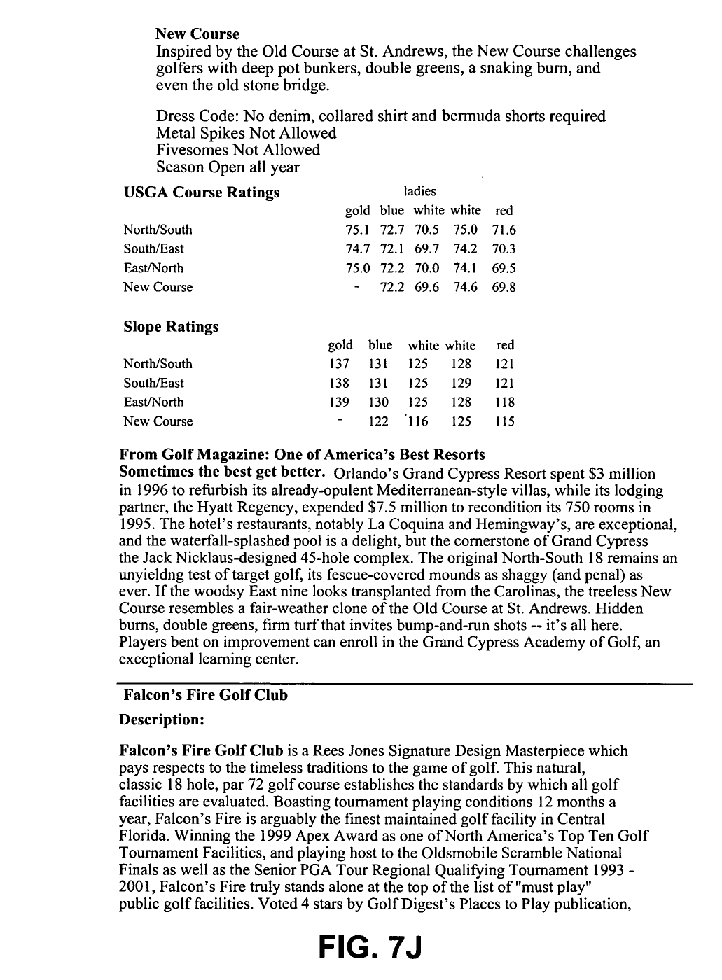

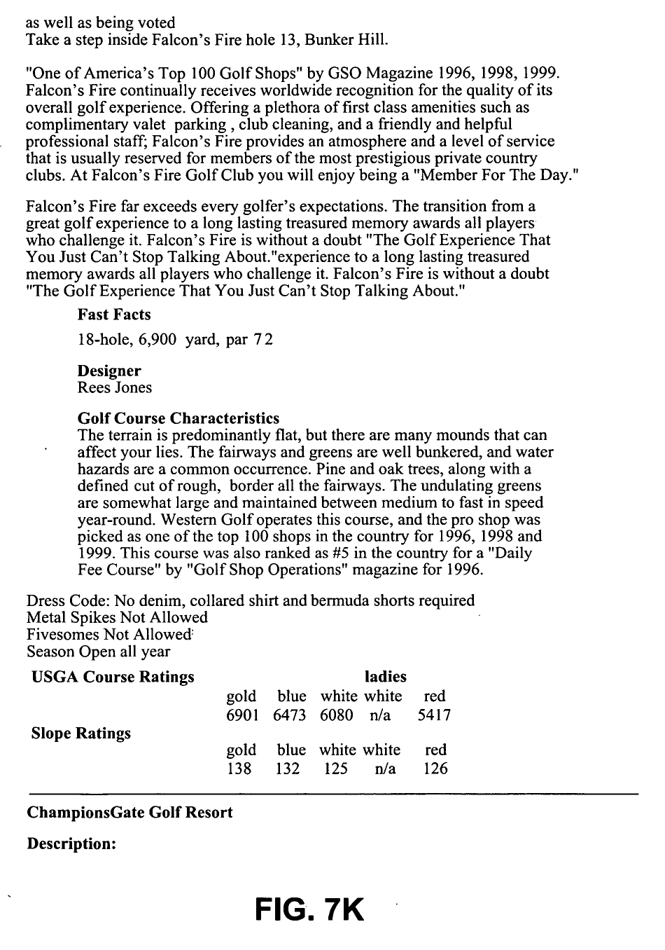

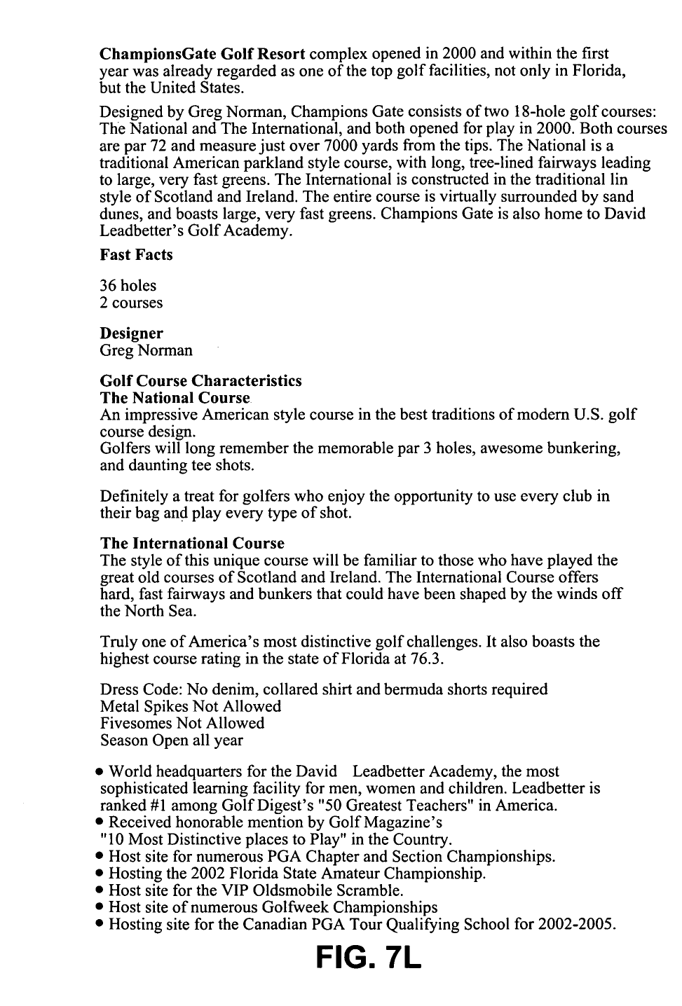

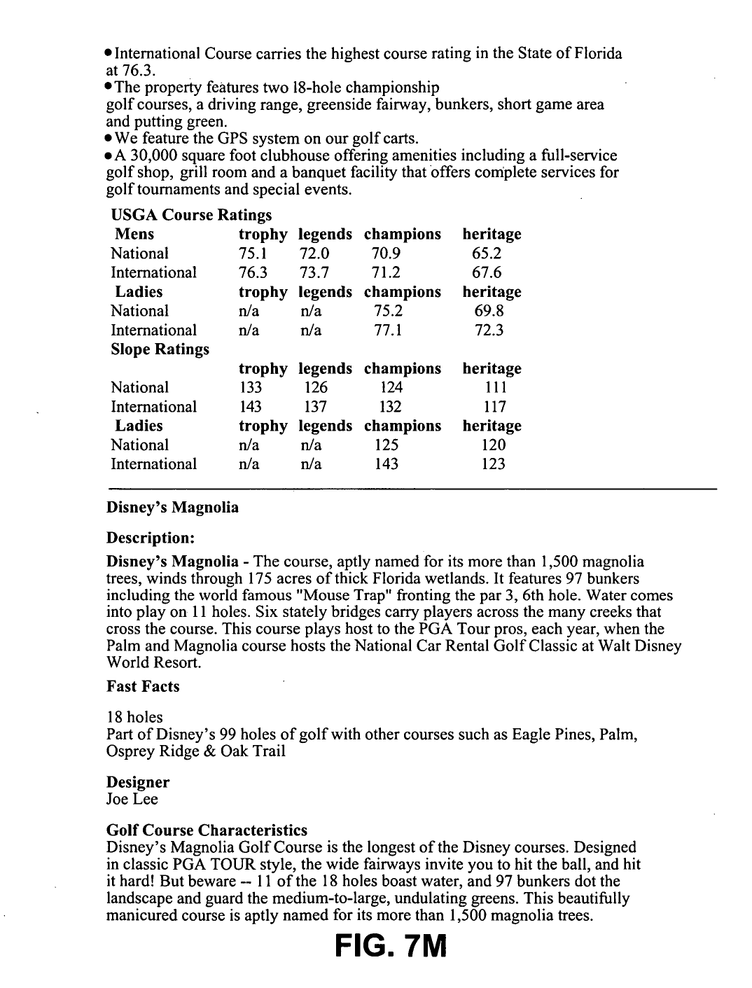

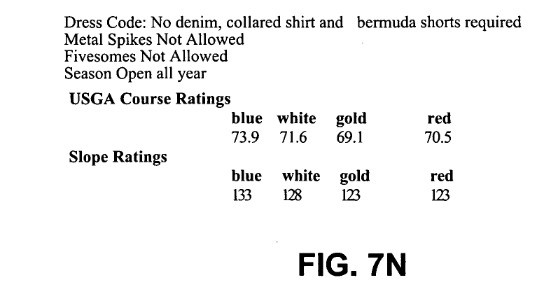

After the submit button 94 is activated, association engine 50, FIG. 3 and assembler 58 produce customized guide 60″, FIGS. 7A-7N. Note the hotel recommendations with a spa and golf course at 210, FIG. 7E and the description of golf courses of FIGS. 7I-7N.

The contrast between the customized guidebook example shown in FIGS. 5A-5S as compared to the customized guidebook shown in FIGS. 7A-7N show that the system of the invention produces customized guidebooks specific to the interests of individual travelers and their companions as a supplement to internet based virtual tours, booking, and other travel industry marketing and advertising endeavors.

One business model of the subject invention is to generate revenue by allowing travel industry partners to sponsor or customize specific guidebooks. So, for example, FIG. 7E shows where sponsor logo 211 could be located if the hotel recommended were a travel industry partner which paid a fee to be listed as a sponsor. Assembler 58, FIG. 3 would automatically place the travel partner's sponsorship information on the guidebook.

Thus, by querying the traveler to generate a traveler profile, matching the traveler profile with a stored set of destination specific guide profiles, and assembling a customized guidebook which includes the guide profile appropriate for the traveler based on the traveler profile, the custom destination guidebook system and method of the subject invention provides a new internet related marketing system useful in the travel industry and people booking travel arrangements, tours, and the like.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. A custom destination guidebook system comprising:
a database of guide profiles including destination specific information;
a first routine which generates a profile screen wherein specific data relating to a traveler can be entered to generate a traveler profile;
a software engine configured to associate the traveler profile with one or more guide profiles stored in the database; and
a second routine which assembles a customized guidebook for the traveler for viewing and/or printing.

2. The system of claim 1 in which the database further also includes generic information for the destination added to each customized guidebook.

3. The system of claim 1 in which the guide profiles stored in the database correspond on a one to one basis to different traveler data.

4. The system of claim 1 in which the specific data for each traveler includes the traveler's name, age group, dining preferences, an indication whether children will be traveling, attractions of interest, or recreational activities of interest.

5. The system of claim 4 in which the guide profiles stored in the database include different information for different age travelers, different dining preferences, different information for travelers with and without children, different information for travelers interested in different attractions and different information for travelers interested in different recreational interests.

6. The system of claim 1 in which the second routine associates a sponsor with the customized guidebook.

7. A custom destination guidebook system comprising:
a database including guidebook sections each including at least one unique identifier;
a first routine which allows a user to generate a traveler profile by inputting data specific to the user and which assigns a unique identifier to the inputted data;
a software engine configured to associate the traveler profile with the guidebook sections by correlating the unique identifier assigned to the inputted data with each guidebook section; and
a second routine which assembles a customized guidebook including the guidebook sections having identifiers which match the identifiers associated with the data specific to the traveler for viewing and/or printing by the traveler.

8. The system of claim 7 in which the database further also includes generic information for the destination added to each customized guidebook.

9. The system of claim 7 in which the guide profiles stored in the database correspond on a one to one basis to different traveler data.

10. The system of claim 7 in which the specific data for each traveler includes the traveler's name, age group, dining preferences, an indication whether children will be traveling, attractions of interest, or recreational activities of interest.

11. The system of claim 10 in which the guide profiles stored in the database include different information for different age travelers, different dining preferences, travelers, different information for travelers with and without children, different information for travelers interested in different attractions, and different information for travelers interest in different recreational interests.

12. The system of claim 7 in which the second routine associates a sponsor with the customized guidebook.

13. A method of customizing a guidebook for a traveler, the method comprising:
allowing a traveler to input data related to the traveler;
generating a traveler profile based on the data input;
associating the traveler profile with one or more guide profiles; and
assembling the guide profiles together as a custom guidebook for viewing and/or printing by the traveler.

14. The method of claim 13 in which the database further also includes generic information for the destination added to each customized guidebook.

15. The method of claim 13 in which the guide profiles stored in the database correspond on a one to one basis to different traveler data.

16. The method of claim 13 in which the specific data for each traveler includes the traveler's name, age group, dining preferences, an indication whether children will be traveling, attractions of interest, or recreational activities of interest.

17. The method of claim 16 in which the guide profiles stored in the database include different information for different age travelers, different dining preferences for travelers, different information for travelers with and without children, different information for travelers interested in different attractions, and different information for travelers interest in different recreational interests.

18. The method of claim 13 further including associating a sponsor with the customized guidebook.

19. A method for producing custom destination guidebooks, the method comprising:
allowing a user to generate a traveler profile by inputting data specific to the user;
assigning a unique identifier to the inputted data;
associating the traveler profile with guidebook sections stored in a database by correlating the unique identifier assigned to the inputted data with different guidebook sections; and
assembling a customized guidebook including the guidebook sections having identifiers which match the identifiers associated with the data specific to the traveler for viewing and/or printing by the traveler.

20. A travel partner sponsored custom guidebook method comprising:
allowing a sponsor to sponsor a customized guidebook;
allowing a traveler to generate a traveler profile; and
assembling a customized guidebook for the traveler including guide profiles corresponding to the traveler profile and including information about the travel sponsor.

21. The method of claim 20 further including the sponsor accessing the traveler profile.
